(19) United States
(12) Patent Application Publication
(10) Pub. No.: US 2020/0015149 A1
(43) Pub. Date: Jan. 9, 2020

(54) METHOD OF WIRELESS NETWORK IDENTIFICATION

(71) Applicant: SIAOBAI INC., Taoyuan City (TW)

(72) Inventor: CYUE JHENG-HAO, Taoyuan City (TW)

(21) Appl. No.: 16/502,550

(22) Filed: Jul. 3, 2019

(30) Foreign Application Priority Data
Jul. 6, 2018 (TW) 107123397

(51) Int. Cl. H04W 48/10; H04W 12/08

(52) U.S. Cl. CPC H04W 48/10; H04W 48/16; H04W 12/08

(57) ABSTRACT

The present invention provides a method of wireless network identification. A wireless network includes a master controller (Master), a first access point (AP1), and a second access point (AP2). The master controller (Master) broadcasts a temporal certification, and the first access point (AP1) and the second access point (AP2) respectively processes validation after receiving the temporal certification, and the temporal certifications provided in the first access point (AP1) and the second access point (AP2). After the first access point (AP1) and the second access point (AP2) find a setup group code from the temporal certification, a signal of to be connected is sent to the master controller (Master) by the first access point (AP1) and the second access point (AP2), so as to complete the connection. As a result, the wireless network has the function of identifying the network to achieve fast network connections.

### BACKGROUND OF THE INNOVATION PATENT

### 1. Field of the Innovation patent

The present innovation patent relates to a method of wireless network identification, and more particularly to a method that is capable of being applied to a wireless network so the wireless network has a function of network identification to achieve the effectiveness of fast network connection, and is suitable for wireless network communication or similar systems.

### 2. The Related Arts

The current wireless network (WI-FI) mostly connect to the network through a wireless router as a gate for connecting network, and some users purchase a wireless access device (AP) or a wireless repeater (Repeater) to expand the coverage of the wireless network, but the general wireless network needs to log in to connect to the Internet through identification.

The method of connection identification of wireless network (WI-FI) usually set the wireless network (WI-FI) connection name and password in an electronic device (such as a Computer) in advance, when other wireless access devices (APs) or wireless repeaters (Repeaters) are to be connected to the wireless network (WI-FI), at the first connection, the the connection name and password in the wireless access devices (APs) or wireless repeaters (Repeaters) to be connected should be set same as the connection name and password of the wireless network (WI-FI) via the electronic device (such as a Computer), or the wireless The receiver (AP) or wireless repeater (Repeater) can not find the wireless network (WI-FI) to be connected, so the connection name and password settings mentioned above are very difficult for general user.

### SUMMARY OF THE INNOVATION PATENT

Hence, an embodiment of the present invention provides a method of wireless network identification, which is mainly applied to wireless network, the wireless network includes a master controller (Master), a first access point (AP1) and a second access point (AP2), the master controller (Master) broadcasts a temporal certification, and the first access point (AP1) and the second access point (AP2) respectively processes validation after receiving the temporal certification broadcasted by the master controller (Master), and the temporal certifications provided in the first access point (AP1) and the second access point (AP2). After the first access point (AP1) and the second access point (AP2) find a setup group code from the temporal certification, a signal of to be connected is sent to the master controller (Master) by the first access point (AP1) and the second access point (AP2), so as to complete the connection. As the result, the wireless network has the function of identifying the network to achieve the effectiveness of fast network connection.

The other purpose of the present invention is providing a method of wireless network identification, wherein the master controller (Master) broadcasts a temporal certification, and the temporal certification includes a time counter, an identifier, and a random code, and the random code is one of the elements selected from the group comprising an arbitrary value, an arbitrary time value, an arbitrary date value, and an arbitrary symbol value, and the identifier is an identity setting or an encoding value. Further, the time counter is further a count-up counter or a countdown timer. As the result, the temporal certification broadcasted by master controller (Master) has the function of identifying the network and also has the function of network group identification, and thus to increase the convenience of whole.

### BRIEF DESCRIPTION OF THE DRAWINGS

FIG. 1 is a schematic flow diagram of the main steps of the present invention.

FIG. 2 is a schematic flow diagram of the steps of the third access point (AP3) and the first access point (AP1) of the present invention.

FIG. 3 is a schematic flow diagram of the steps of the fourth access point (AP4) and the second access point (AP2) of the present invention.

FIG. 4 is a main architecture diagram of the present invention.

FIG. 5 is a schematic architecture diagram of the third access point (AP3) and the fourth access point (AP4) of the present invention.

### DETAILED DESCRIPTION OF PREFERRED EMBODIMENT

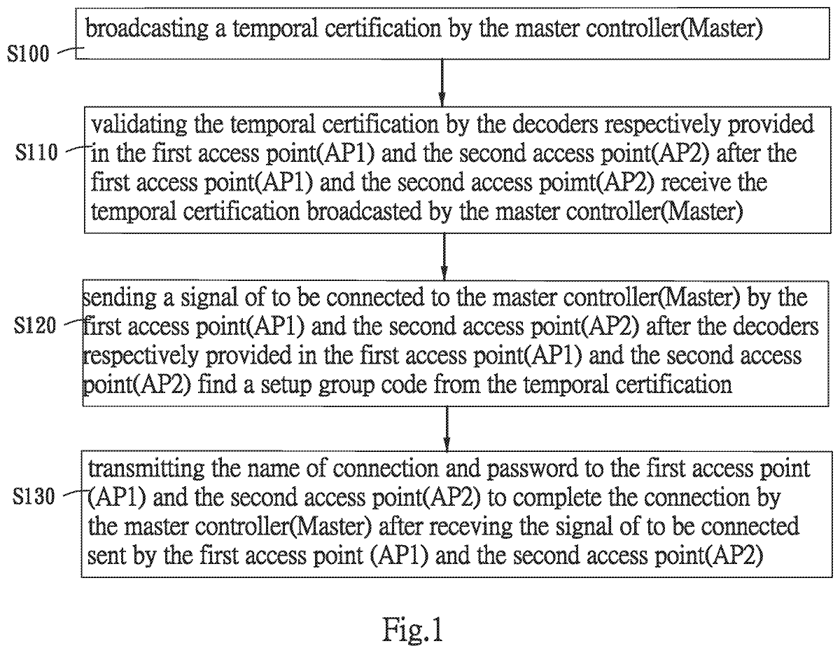

With reference to FIGS. 1 to 5, FIGS. 1 to 5 are schematic of an embodiment of the present invention, and the best embodiment of the method of wireless network identification of the present invention is applied to a wireless network. In this way, the wireless network has the function of identifying the network to achieve the effectiveness of fast network connection, and it also add the function of network group identification.

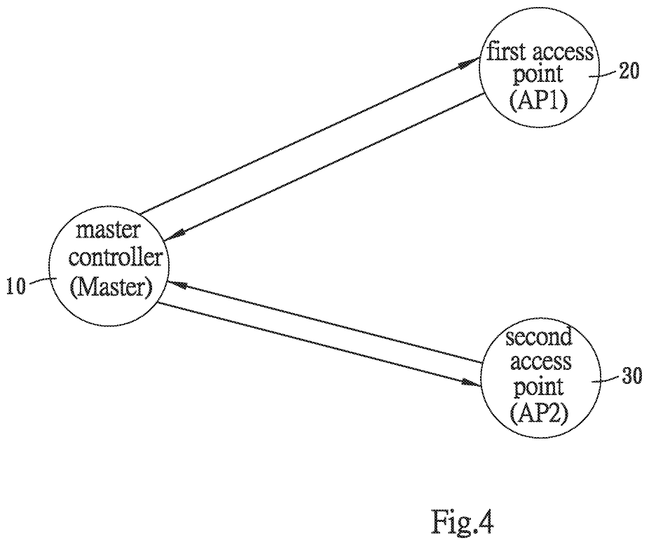

The method of wireless network identification of the present invention is mainly applied to a wireless network, and the wireless network includes a master controller (Master) 10, a first access point (AP1) 20, and a second access point (AP2) 30 (as shown in FIG. 4). Specifically, the master controller (Master) 10 is a device with network function, and the device one of the elements selected from the group comprising a computer with wireless-network function, a handheld mobile device, a wireless router, an access point, a repeater, an extender, or a wireless client, and the first access point (AP1) 20 and the second access point (AP2) 30 are the devices with network function, and the device is one of the elements selected from the group comprising a computer with wireless-network function, a handheld mobile device, a wireless router, an access point, a repeater, an extender, or a wireless client. The above-mentioned wireless client (Client) is one of the elements selected from the group comprising a personal computer (PC) with wireless network function, a thin computer (Thin Client), a tablet (Tablet Personal Computer), a notebook computer (NoteBook), a smart mobile phone. (Mobile phone) and a palm computer (Personal Digital Assistant) and a wireless network module with wireless network function (WI-FI module).

Firstly, the step to be performed is step S100: broadcasting a temporal certification by the master controller (Master) 10. That is, the master controller (Master) 10 broadcasts a temporal certification within a certain time, which the certain time is set in minutes or seconds, such as 3 minutes or 180 seconds. Specifically, the temporal certification includes a time counter, an identifier, and a random code, and the random code is one of the elements selected from the group comprising an arbitrary value, an arbitrary time value, an arbitrary date value, and an arbitrary symbol value, and the identifier is an identity setting or an encoding value. In addition, the identification code is any one of an identity set value or an encoded value, and the time counter is a count-up counter or a countdown counter. After the above step S100 is completed, the next step S110 will be performed (as shown in FIG. 1).

Next, the step to be performed is step S110: validating the temporal certification by the decoders respectively provided in the first access point (AP1) 20 and the second access point (AP2) 30 after the first access point (AP1) 20 and the second access point (AP2) 30 receive the temporal certification broadcasted by the master controller (Master) 10.

In addition, the step to be performed is step S120: sending a signal of to be connected to the master controller (Master) 10 by the first access point (AP1) 20 and the second access point (AP2) 30 after the decoders respectively provided in the first access point (AP1) 20 and the second access point (AP2) 30 find a setup group code from the temporal certification. That is, when the decoders provided in the first access point (AP1) 20 and the second access point (AP2) 30 validate the temporal certifications, and the setup parameter, value, or group code is found in the temporal certification, and the authentication procedure of the certification is performed, thus the first access point (AP1) 20 and the second access point (AP2) 30 will respectively send the signal of to be connected to the master controller (Master) 10, so the master controller (Master) 10 will know that the first access point (AP1) 20 and the second access point (AP2) 30 are in the same group, so it can perform the connection. After the above step S120 is completed, the next step S130 will be performed.

In addition, the step to be performed is step S130: transmitting the name of connection and password to the first access point (AP1) 20 and the second access point (AP2) 30 to complete the connection by the master controller (Master) 10 after receiving the signal of to be connected sent by the first access point (AP1) 20 and the second access point (AP2) 30. That is, when the master controller (Master) 10 receives the signal of to be connected sent by the first access point (AP1) 20 and the second access point (AP2) 30 and confirm that the first access point (AP1) 20 and the second access point (AP2) 30 are in the same group, which can be connected, thus the name of connection and password will be transmitted to the first access point (AP1) 20 and the second access point (AP2) 30, so the name of connection and the password of the master controller (Master) 10 will be stored by the first access point (AP1) 20 and the second access point (AP2) 30 so as to complete the connection.

After completing the step S130, the first access point (AP1) 20 and the second access point (AP2) 30 not only can connect to the master controller (Master) 10, but also can be used as a relay station to search any access points (APs) that can be connected. Therefore, after the master controller (Master) 10 is connected to the first access point (AP1) 20, the following steps will be performed.

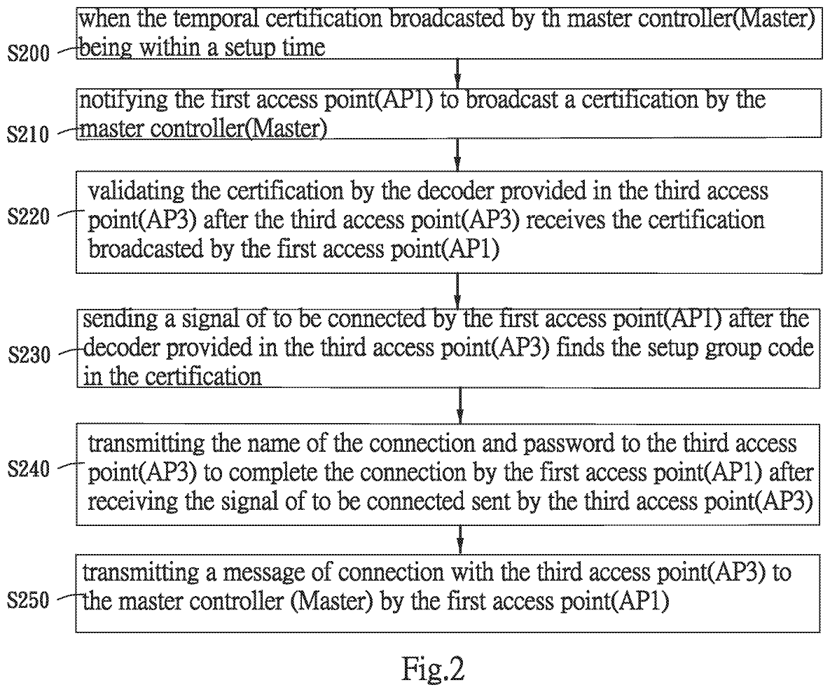

Firstly, the step to be performed is step S200: when a temporal certification broadcasted by the master controller (Master) 10 being within a setup time. That is, when the master controller (Master) 10 has connected to the first access point (AP1) 20, because the temporal certification broadcasted by the master controller (Master) 10 has a temporal setup, such as 3 minutes or 180 seconds, thus the master controller (Master) 10 is able to broadcast within the setup time so as to find the access point (AP). After the above step S200 is completed, the next step S210 will be performed (as shown in FIG. 2).

In addition, the step to be performed is step S210: notifying the first access point (AP1) 20 to broadcast a certification by the master controller (Master) 10. That is, when the temporal certification broadcasted by the master controller (Master) 10 does not exceed the setup time, the master controller (Master) 10 will notify the first access point (AP1) 20 to broadcast a certification, wherein the certification includes a time counter, an identifier, and a random code, and the random code is one of the elements selected from the group comprising an arbitrary value, an arbitrary time value, an arbitrary date value, and an arbitrary symbol value, and the identifier is an identity setting or an encoding value. After the above step S210 is completed, the next step S220 will be performed.

In addition, the step to be performed is step S220: validating the certification by the decoder provided in the third access point (AP3) 40 after the third access point (AP3) 40 receives the certification broadcasted by the first access point (AP1) 20. That is, when the first access point (AP1) 20 broadcasts a certification, the third access point (AP3) 40 will receive the certification broadcasted by the first access point (AP1) 20, because the third access point (AP3) 40 is provided with a decoder, the setup parameter, value, or group code in the received certification will be validated by the decoder so as to determine whether an authentication procedure of the certification is performed or not.

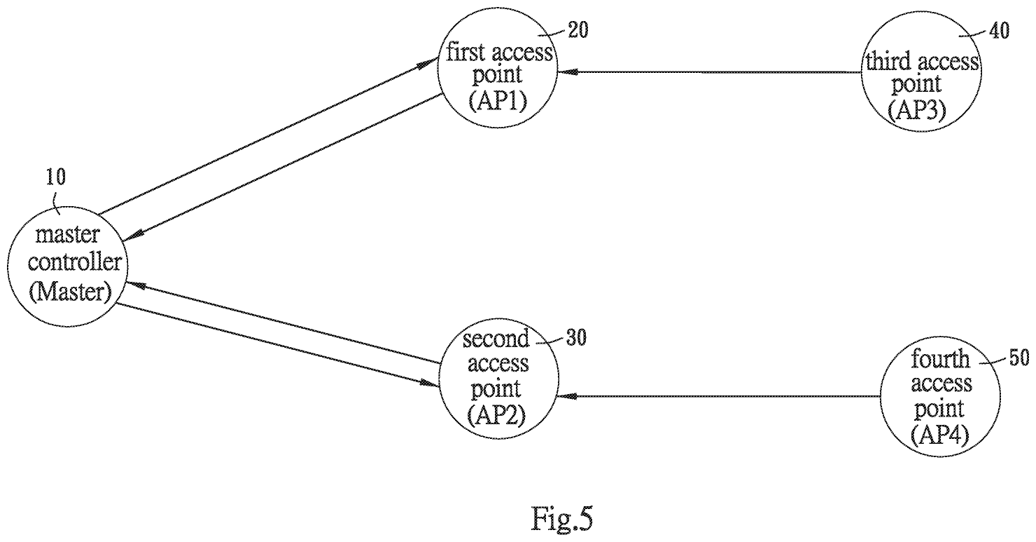

Specifically, the third access point (AP3) 40 (as shown in FIG. 5) is a devices with network function, and the device is one of the elements selected from the group comprising a computer with wireless-network function, a handheld mobile device, a wireless router, an access point, a repeater, an extender, or a wireless client. The above-mentioned wireless client (Client) is one of the elements selected from the group comprising a personal computer (PC) with wireless network function, a thin computer (Thin Client), a tablet (Tablet Personal Computer), a notebook computer (NoteBook), a smart mobile phone. (Mobile phone) and a palm computer (Personal Digital Assistant) and a wireless network module with wireless network function (WI-FI module). After the above step S220 is completed, the next step S230 will be performed.

In addition, the step to be performed is step S230: sending a signal of to be connected by the first access point (AP1) 20 after the decoder provided in the third access point (AP3) 40 finds the setup group code in the certification. That is, when the decoder of the third access point (AP3) 40 verifies the certification, and the setup parameter, value, or group code is found in the certification, and the authentication procedure of the certification is performed, thus the third access point (AP3) 40 will send a signal of to be connected to the first access point (AP1) 20, so the first access point (AP1) 20 will know that the third access point (AP3) 40 and the first access point (AP1) 20 are in the same group, so it can perform the connection. After the above step S230 is completed, the next step S240 will be performed.

In addition, the step to be performed is step S240: transmitting the name of the connection and password to the third access point (AP3) 40 to complete the connection by the first access point (AP1) 20 after receiving the signal of to be connected sent by the third access point (AP3) 40. That is, when the first access point (AP1) 20 receives the signal of to be connected sent by the third access point (AP3) 40 and confirm that the third access point (AP3) 40 is in the same group, which can be connected, thus the name of connection and password will be transmitted to the third access point (AP3) 40, so the name of connection and the password of the first access point (AP1) 20 will be stored by the third access point (AP3) 40 so as to complete the connection. After the above step S240 is completed, the next step S250 will be performed.

In addition, the step to be performed is step S250 transmitting a message of connection with the third access point (AP3) 40 to the master controller (Master) 10 by the first access point (AP1) 20. That is, when the third access point (AP3) 40 completes the connection with the first access point (AP1) 20, the first access point (AP1) 20 will transmit message of connection with the third access point (AP3) 40 to the master controller (Master) 10, so the master controller (Master) 10 is able to broadcast data or message to the third access point (AP3) 40 via the first access point (AP1) 20 so as to form a working group.

Furthermore, After completing the step S130, the first access point (AP1) 20 and the second access point (AP2) 30 not only can connect to the master controller (Master) 10, but also can be used as a relay station to search any access points (APs) that can be connected. Therefore, after the master controller (Master) 10 being connected to the second access point (AP2) 20, the following steps will be performed.

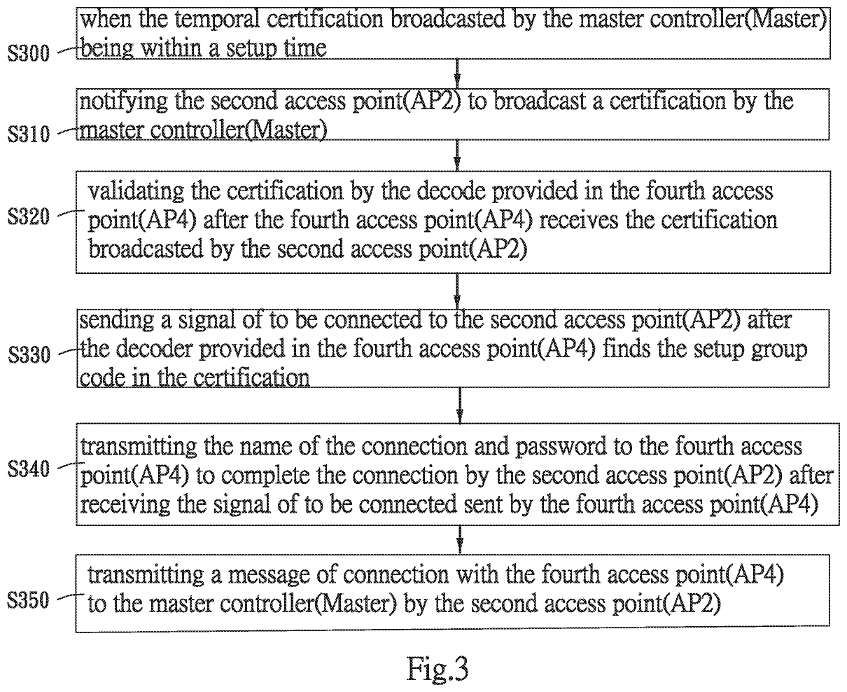

Firstly, the step to be performed is step S300: when a temporal certification broadcasted by the master controller (Master) 10 being within a setup time. That is, when the master controller (Master) 10 has connected to the second access point (AP2) 30, because the temporal certification broadcasted by the master controller (Master) 10 has a temporal setup, such as 3 minutes or 180 seconds, thus the master controller (Master) 10 is able to broadcast within the setup time so as to find the access point (AP). After the above step S300 is completed, the next step S310 will be performed (as shown in FIG. 3).

In addition, the step to be performed is step S310: notifying the second access point (AP2) 30 to broadcast a certification by the master controller (Master) 10. That is, when the temporal certification broadcasted by the master controller (Master) 10 does not exceed the setup time, the master controller (Master) 10 will notify the second access point (AP2) 30 to broadcast a certification, wherein the certification includes a time counter, an identifier, and a random code, and the random code is one of the elements selected from the group comprising an arbitrary value, an arbitrary time value, an arbitrary date value, and an arbitrary symbol value, and the identifier is an identity setting or an encoding value. After the above step S310 is completed, the next step S320 will be performed.

In addition, the step to be performed is step S320: validating the certification by the decoder provided in the fourth access point (AP4) 50 after the fourth access point (AP4) 50 receives the certification broadcasted by the second access point (AP2) 30. That is, when the second access point (AP2) 30 broadcasts a certification, the fourth access point (AP4) 50 will receive the certification broadcasted by the second access point (AP2) 30, because the fourth access point (AP4) 50 is provided with a decoder, the setup parameter, value, or group code in the received certification will be validated by the decoder so as to determine whether an authentication procedure of the certification is performed or not.

Specifically, the fourth access point (AP4) 50 (as shown in FIG. 5) is a devices with network function, and the device is one of the elements selected from the group comprising a computer with wireless-network function, a handheld mobile device, a wireless router, an access point, a repeater, an extender, or a wireless client. The above-mentioned wireless client (Client) is one of the elements selected from the group comprising a personal computer (PC) with wireless network function, a thin computer (Thin Client), a tablet (Tablet Personal Computer), a notebook computer (NoteBook), a smart mobile phone. (Mobile phone) and a palm computer (Personal Digital Assistant) and a wireless network module with wireless network function (WI-FI module). After the above step S320 is completed, the next step S330 will be performed.

In addition, the step to be performed is step S330: sending a signal of to be connected by the second access point (AP2) 30 after the decoder provided in the fourth access point (AP4) 50 finds the setup group code in the certification. That is, when the decoder of the fourth access point (AP4) 50 verifies the certification, and the setup parameter, value, or group code is found in the certification, and the authentication procedure of the certification is performed, thus the fourth access point (AP4) 50 will send a signal of to be connected to the second access point (AP2) 30, so the second access point (AP2) 30 will know that the fourth access point (AP4) 50 and the second access point (AP2) 30 are in the same group, so it can perform the connection. After the above step S230 is completed, the next step S240 will be performed.

In addition, the step to be performed is step S340: transmitting the name of the connection and password to the fourth access point (AP4) 50 to complete the connection by the second access point (AP2) 30 after receiving the signal of to be connected sent by the fourth access point (AP4) 50. That is, when the second access point (AP2) 30 receives the signal of to be connected sent by the fourth access point (AP4) 50 and confirm that the fourth access point (AP4) 50 is in the same group, which can be connected, thus the name of connection and password will be transmitted to the fourth access point (AP4) 50, so the name of connection and the password of the second access point (AP2) 30 will be stored by the fourth access point (AP4) 50 so as to complete the connection. After the above step S340 is completed, the next step S250 will be performed.

In addition, the step to be performed is step S350: transmitting a message of connection with the fourth access point (AP4) 50 to the master controller (Master) 10 by the second access point (AP2) 30. That is, when the fourth access point (AP4) 50 completes the connection with the second access point (AP2) 30, the second access point (AP2) 30 will transmit message of connection with the fourth access point (AP4) 50 to the master controller (Master) 10, so the master controller (Master) 10 is able to broadcast data or message to the fourth access point (AP4) 50 via the second access point (AP2) 30 so as to form a working group.

The advantage and features of the present invention will be described below, and as can be appreciated from the above embodiments, a person skilled in the art can achieve the above object. Therefore, the present innovation patent has industry worth which meets the requirement for a patent, so that the application is submitted.

1. A method of wireless network identification for use in a wireless network including a master controller (Master), a first access point (AP1) and a second access point (AP2), the method of wireless network identification comprising:
broadcasting a temporal certification by the master controller (Master);
validating the temporal certification by decoders provided in the first access point (AP1) and the second access point (AP2), respectively, after the first access point (AP1) and the second access point (AP2) receive the temporal certification broadcasted by the master controller (Master);
sending a signal of to be connected to the master controller (Master) by the first access point (AP1) and the second access point (AP2) after the decoders provided in the first access point (AP1) and the second access point (AP2) identify a setup group code from the temporal certification; and
transmitting a connection name and a password to the first access point (AP1) and the second access point (AP2) to complete the connection by the master controller (Master) after receiving the signal of to be connected sent by the first access point (AP1) and the second access point (AP2).

2. The method of wireless network identification of claim 1, wherein:
the temporal certification further comprises a time counter, an identifier, and a random code
the random code is selected from a group comprising: an arbitrary value, an arbitrary time value, an arbitrary date value, and an arbitrary symbol value; and
the identifier is an identity setting or an encoding value.

3. The method of wireless network identification of claim 1, wherein the time counter is a count-up counter or a countdown counter.

4. The method of wireless network identification of claim 1, wherein after the master controller (Master) connects with the first access point (AP1), the method further comprises:
identifying when the temporal certification broadcasted by the master controller (Master) is within a setup time;
notifying the first access point (AP1) to broadcast a certification by the master controller (Master);
validating the certification by the decoder provided in the third access point (AP3) after the third access point (AP3) receives the certification broadcasted by the first access point (AP1);
sending a signal of to be connected by the first access point (AP1) after the decoder provided in the third access point (AP3) finds the setup group code in the certification;
transmitting the name of the connection and password to the third access point (AP3) to complete the connection by the first access point (AP1) after receiving the signal of to be connected sent by the third access point (AP3); and
transmitting a message of connection with the third access point (AP3) to the master controller (Master) by the first access point (AP1).

5. The method of wireless network identification of claim 1, wherein after the master controller (Master) connects with the second access point (AP2), the method further comprises:
identifying when the temporal certification broadcasted by the master controller (Master) is within a setup time;
notifying the second access point (AP2) to broadcast a certification by the master controller (Master);
validating the certification by the decoder provided in the fourth access point (AP4) after the fourth access point (AP4) receives the certification broadcasted by the second access point (AP2);
sending a signal of to be connected to the second access point (AP2) after the decoder provided in the fourth access point (AP4) finds the setup group code in the certification;
transmitting the name of the connection and password to the fourth access point (AP4) to complete the connection by the second access point (AP2) after receiving the signal of to be connected sent by the fourth access point (AP4); and
transmitting a message of connection with the fourth access point (AP4) to the master controller (Master) by the second access point (AP2).

6. The method of wireless network identification of claim 4, wherein:
the temporal certification further includes an identifier and a random code;
the random code is selected from a group comprising: an arbitrary value, an arbitrary time value, an arbitrary date value, and an arbitrary symbol value; and
the identifier is an identity setting or an encoding value.

7. The method of wireless network identification of claim 1, wherein the master controller (Master) is a device with a network function, and the device is selected from a group comprising: a computer with a wireless-network function, a handheld mobile device, a wireless router, an access point, a repeater, an extender, and a wireless client.

8. The method of wireless network identification of claim 1, wherein the first access point (AP1) and the second access point (AP2) each include a device with a network function, and the device is selected from a group comprising: a computer with a wireless-network function, a handheld mobile device, a wireless router, an access point, a repeater, an extender, and a wireless client.

9. The method of wireless network identification of claim 4, wherein the third access point (AP3) is a device with a network function, and the device is selected from a group comprising: a computer with a wireless-network function, a handheld mobile device, a wireless router, an access point, a repeater, an extender, and a wireless client.

10. The method of wireless network identification of claim 5, wherein the fourth access point (AP4) is a device with a network function, and the device is selected from a group comprising: a computer with a wireless-network function, a handheld mobile device, a wireless router, an access point, a repeater, an extender, and a wireless client.
